(19) United States
(12) Patent Application Publication
(10) Pub. No.: US 2005/0119475 A1
(43) Pub. Date: Jun. 2, 2005

(54) Method of separating glycolipids

(76) Inventors: Takahiro Ishikawa, Okinawa (JP); Akira Yamaguchi, Yokohama (JP); Kyoko Suzuki, Yokohama (JP); Kayoko Katsuyama, Nagano (JP)

Correspondence Address: POSZ LAW GROUP, PLC, 12040 SOUTH LAKES DRIVE, SUITE 101, RESTON, VA, 20191, US

(21) Appl. No.: 10/825,210

(22) Filed: Apr. 16, 2004

(30) Foreign Application Priority Data
Oct. 18, 2001 (JP) 2001-321157
Dec. 21, 2001 (WO) PCT/JP01/11281

(51) Int. Cl. C08B 37/00

(52) U.S. Cl. 536/53

(57) ABSTRACT

With the object of providing a method for separating glycolipids (particularly gangliosides) capable of processing a large number of samples easily and at low cost, and capable of recovering multiple types of glycolipids with high recovery, in the method for separating glycolipids of the present invention (a) a sample solution obtained by hydrolysis of an extract derived from a biological sample with a mixture of a nonpolar solvent and a polar solvent is first brought into contact via a semipermeable membrane with a solution having lower osmotic pressure than the sample solution, and (b) the contact is continued until the sample solution divides into two or three layers, and the middle layer and/or bottom layer are/is separated.

### TECHNICAL FIELD

The present invention relates to a method for separating glycolipids from a sample solution.

### BACKGROUND ART

The fact that structural changes occur in the sugar chains of glycolipids in cell membranes and cells in association with cell differentiation and canceration suggests that glycolipids play a vital role in cell differentiation and proliferation, and the biological functions of glycolipids are the focus of intense research. In order to elucidate the biological functions of glycolipids it is necessary to obtain purified glycolipids, but chemical synthesis of sugar chains is not easy. Consequently, it is necessary to separate glycolipids from biological samples.

Hereditary defects in glycolipid degrading enzymes are a cause of glycolipid storage disorders. An example is GM2 storage disorder (gangliosidosis), in which gangliosides accumulate in the brain and other tissues due to hereditary defect of lysosomal enzymes associated with degradation of the sugar side-chains of gangliosides, which are one kind of glycolipid. GA2 and GM2 storage disorders have already been confirmed in humans and other mammals, and GM2 storage disorder is classified into Sandhoff disease, Tay-Sachs disease and AB type GM2 gangliosidosis, depending on the deficient enzyme. GM1, GM2 and the like are terms based on the nomenclature of Svennerholm, wherein molecules with 1, 2, 3, 4 and 5 sialic acids are called GM, GD, GT, GQ and GP, respectively, and the numbers 1, 2, 3 and 4 are assigned to those with the basic sugar chains Gg₄Cer, Gg₃Cer, LacCer and GalCer. Separation of glycolipids from biological samples is also necessary for diagnosing and understanding the pathology of such glycolipid storage disorders.

A method commonly used for separating glycolipids from biological samples is for example to first extract total lipids from tissue, cells or the like, and then remove simple lipids and phospholipids from the total lipids to separate the glycolipids. Methods used for removing simple lipids and phospholipids from total lipids to separate glycolipids include biphasic partition, chromatography (such as DEAE-Sephadex or other anion-exchange chromatography, alone or in combination with silica gel chromatography), and mild alkali hydrolysis.

Widely-used biphasic partition methods are Folch partition and a modification thereof, Bligh-Dyer extraction. In Folch partition, 1/5 part by volume of water or 0.75% to 0.9% aqueous KCl is added to lipids extracted with chloroform-methanol (2:1 (v/v)) and stirred so that the water-methanol top layer separates from the chloroform bottom layer. The water-soluble gangliosides are extracted in the top layer, and other total lipids in the bottom layer. However, because gangliosides with short sugar chains (GM4, GM3 and the like) tend to be partitioned in the lower layer, chromatography is currently more widely used than biphasic partition. Moreover, when phospholipids are removed by mild alkali hydrolysis, a desalting operation by dialysis or the like is required.

### DISCLOSURE OF THE INVENTION

As described above, a variety of methods have been developed for removing simple lipids and phospholipids from total lipids to separate glycolipids, but the advantages of these various methods are offset by disadvantages in terms of recovery and purity of glycolipids, or trouble and cost. For example, chromatography involves troublesome pre-processing of the sample, and is unsuitable for processing a large number of samples because of the cost. In mild alkali hydrolysis it is thought that dialysis to remove salts lowers the recovery of glycolipids.

Therefore, it is an object of the present invention to provide a method for separating glycolipids (particularly gangliosides) wherein a large number of samples can be processed easily at a low cost, and multiple kinds of glycolipids can be recovered with high recovery rates.

In order to achieve this object, the present invention provides the method for separating glycolipids and method for separating gangliosides of (1) through (6) below.

(1) A method for separating glycolipids, comprising:
(a) a step in which a sample solution obtained by hydrolysis of an extract derived from a biological sample with a mixture of a nonpolar solvent and a polar solvent is brought into contact via a semipermeable membrane with a solution having lower osmotic pressure than the sample solution; and
(b) a step in which the contact is continued until the sample solution divides into two or three layers, and the middle layer and/or bottom layer are/is separated.

(2) The method according to (1) above, wherein the glycolipids are gangliosides, and the contact in step (b) is continued until the sample solution divides into three layers and the middle layer is separated.

(3) The method according to (1) or (2) above, wherein the biological sample comprises a cell or tissue of an animal or plant, or a microbial body.

(4) The method according to any of (1) through (3) above, wherein the nonpolar solvent is chloroform, pyridine or a mixture of these, and the polar solvent is water, methanol, sodium acetate or a mixture of two or more of these.

(5) The method according to any of (1) through (3) above, wherein the mixture of the nonpolar solvent and the polar solvent is a mixture of water, methanol, chloroform and pyridine.

(6) The method according to any of claims (1) through (5) above, wherein the sample solution is obtained by hydrolyzing and then neutralizing the extract.

### BRIEF DESCRIPTION OF THE DRAWINGS

FIG. 1 shows the development results from thin layer chromatography of a top layer, middle layer and bottom layer obtained by a method for separating glycolipids according to the present invention;

FIG. 2 shows the development results from thin layer chromatography of glycolipids obtained by a method for separating glycolipids according to the present invention and a conventional method; and

FIG. 3 shows the development results for thin layer chromatography of glycolipids obtained from various tissues by a method for separating glycolipids of the present invention.

### BEST MODE FOR CARRYING OUT THE INVENTION

The present invention is explained in detail below.

The method for separating glycolipids of the present invention comprises the following steps:
(a) a step in which a sample solution obtained by hydrolysis of an extract derived from a biological sample with a mixture of a nonpolar solvent and a polar solvent is brought into contact via a semipermeable membrane with a solution having lower osmotic pressure than the sample solution; and
(b) a step in which the contact is continued until the sample solution divides into two or three layers, and the middle layer and/or bottom layer are/is separated.

“Glycolipid” is a general term for substances containing both a water-soluble sugar chain and a lipid-soluble group within the molecule. These are generally divided into sphingoglycolipids and glyceroglycolipids depending on the lipid-soluble group, but in the broad sense glycolipids also include glycosides with lipid-soluble groups (for example, steroids, hydroxy fatty acids and the like) such as steryl glycosides, steroid glycosides, rhamnolipids and the like. Moreover, glycolipids having sialic acid, uronic acid, sulfuric acid, phosphoric acid and the like (such as gangliosides, sulfatides, sulfolipids and the like) are known as acidic glycolipids to distinguish them from neutral glycolipids. Of these, the glycolipids to be separated in the present invention may be any kind of glycolipids, but it is preferable that the glycolipids to be separated in the present invention be gangliosides. The separation method of the present invention has excellent effects in particular when the objects of separation are gangliosides. “Ganglioside” is a general term for sphingoglycolipids which contain sialic acid, but in the present invention gangliosides having the sialic acid removed, namely asialogangliosides, are also included as “gangliosides”.

The respective steps are explained below.

Step (a)

Step (a) is a step in which a sample solution obtained by hydrolysis of an extract derived from a biological sample with a mixture of a nonpolar solvent and a polar solvent is brought into contact via a semipermeable membrane with a solution having lower osmotic pressure than the sample solution.

The “sample solution” is obtained by hydrolysis of an extract obtained by extracting from a biological sample with a mixture of a nonpolar solvent and a polar solvent.

The “biological sample” is a sample derived from an animal, plant, microorganism or other living organism, and is not particularly limited as to type as long as it contains glycolipids to be separated. Examples of biological samples include cells or tissues of plants or animals, or microbial bodies. There are no particular limits on the species of animal, plant or microorganism or on the type of cells or tissue. For example, sphingoglycolipids are distributed among animals and microbes, forming structural components of their cells membranes, so they are contained in biological samples derived from animals or microorganisms. Similarly, glyceroglycolipids are present in gram-positive bacteria and the chloroplasts of higher plants, so they are contained in biological samples derived from plants or microorganisms.

Biological samples contain simple lipids and phospholipids (such as glycerophospholipids and sphingophospholipids) in addition to glycolipids, and when a biological sample is extracted with a mixture of a nonpolar solvent and a polar solvent, these lipids are extracted as a mixture. There are no particular limitations on the conditions for extracting lipids from a biological sample as long as they allow extraction of the glycolipids to be separated using a mixture of a nonpolar solvent and a polar solvent, and ordinary methods may be followed. Normally, conditions are established so as to extract as much as possible of the total lipids (simple lipids and complex lipids) contained in the biological sample. The biological sample may be previously homogenized for purposes of extraction.

A mixture of a nonpolar solvent and a polar solvent is used for extraction of lipids from a biological sample, but the state of the lipids in the biological sample is taken into consideration in determining the types, mixing ratio and the like of these extraction solvents. That is, since lipids normally form complexes with macromolecules in the body (such as proteins and other lipids) via bonds such as van der Waals force bonds, hydrophobic bonds, hydrogen bonds, electrostatic bonds, covalent bonds and the like, the types, mixing ratio and the like of the extraction solvents are determined so as to allow cleavage of these bonds. The types, mixing ratio and the like of the extraction solvents are also selected so that when the mixture is left it divides into two phases, a nonpolar solvent phase and a polar solvent phase.

A nonpolar organic solvent such as chloroform, pyridine or the like or a mixture of two or more of these may be used as the nonpolar solvent. Water, a polar organic solvent such as methanol, sodium acetate or a mixture of two or more of these may be used as the polar solvent.

Of these, it is preferable that chloroform and pyridine be selected for the nonpolar solvent, that water and methanol be selected for the polar solvent, and that a mixture of water, methanol, chloroform and pyridine be used as the extraction solvent.

The mixing ratio of nonpolar solvent to polar solvent is normally 1:1 to 10:1 (capacity ratio), or preferably 1:1 to 2:1 (capacity ratio). When a mixture of chloroform, methanol, water and pyridine is used as the extraction solvent, the mixing ratio of these may be for example 2:1:1:0.03 to 4:2:1:0.03.

Extraction of lipids from a biological sample is normally performed at room temperature. When extracting plant lipids, an extraction solvent containing alcohol is preferably used to prevent degradation of the lipids by phospholipase, lipase or the like.

In addition to extracts obtained by extraction of a biological sample with a mixture of a nonpolar solvent and a polar solvent, products obtained by application of desired processes thereto are also included as “extracts obtained by extraction of a biological sample with a mixture of a nonpolar solvent and a polar solvent”. Examples of processes which can be applied to the extract include filtration, condensation, dilution and purification (for example purification by silica gel chromatography, ion chromatography and the like), and such processes are performed to the extent that they do not break down lipids contained in the extract. Such processes may also be applied after hydrolysis is performed.

Hydrolysis performed on an extract obtained by extraction of a biological sample with a mixture of a nonpolar solvent and a polar solvent is performed so as to achieve cleavage of ester bonds of lipids contained in the extract (such as phospholipid ester bonds and ester bonds of complexes of biological macromolecules and lipids). Hydrolysis can be performed according to ordinary methods using alkali or acid. Hydrolysis is preferably performed using mild alkali.

An extract obtained by extraction of a biological sample with a mixture of a nonpolar solvent and a polar solvent is preferably neutralized after being hydrolyzed. In this way, glycolipids can be separated with greater recovery and purity. Neutralization can be performed using acids if hydrolysis is with alkali or using alkali if hydrolysis is with acid, and there are no particular limits on the types of alkali and acid used therefor.

A sample solution obtained as described above contains simple lipids, phospholipids and the like in addition to the glycolipids to be separated.

The solution which is brought into contact with the sample solution via a semipermeable membrane is a solution with a lower osmotic pressure than the sample solution (referred to hereunder as “hypotonic solution”), and is not particular limited as to type. Water or buffer (such as TE) for example can be used as the hypotonic solution.

The semipermeable membrane is a membrane which allows passage of small molecules but not macromolecules. A semipermeable membrane commonly used for dialysis can be used as the semipermeable membrane, with no particular limitations on type. For example, a cellophane membrane, collodion membrane, denitration collodion membrane, gel cellophane membrane, parchment paper, polyvinyl alcohol membrane, natural bladder membrane, air bladder membrane, artificial parchment paper, cellulose dialysis membrane or the like can be used, and of these a cellulose dialysis membrane is particularly desirable.

The part of the sample solution which contacts the hypotonic solution may be all or part of the sample solution. If it is part, it may be any part of the sample solution. As long as any part of the sample solution contacts the hypotonic solution via the semipermeable membrane the sample solution will divide into two or three layers, but since the time it takes for the sample solution to divide into two or three layers is shorter the more parts contact the hypotonic solution via the semipermeable membrane, it is better that as much part as possible contacts the hypotonic solution via the semipermeable membrane.

Methods ordinarily used for dialysis can be used for bringing the sample solution into contact with the hypotonic solution via the semipermeable membrane. For example, a method can be adopted in which the sample solution is placed in a tube of semipermeable membrane with one end tied, which is then immersed in the hypotonic solution after the other end has been tied shut. A method can also be adopted in which a container capable of containing liquid is divided into two chambers by means of the semipermeable membrane, and the sample solution and hypotonic solution are added to the respective chambers.

Step (b)

Step (b) is a step in which the contact of Step (a) is continued until the sample solution divides into two or three layers, and the middle layer and/or bottom layer are/is separated.

When a sample solution is brought into contact with a hypotonic solution via a semipermeable membrane and this contact is continued, the sample solution forms two or three layers. In order to continue the contact it is sufficient to leave them after they are brought into contact, but the hypotonic solution can also be stirred or replaced with new hypotonic solution. The time it takes for the sample solution to form two or three layers differs depending on the contact area between the sample solution and hypotonic solution and on the type of hypotonic solution, but normally they can be left for about 3 to 6 hours.

When contact of the sample solution with the hypotonic solution via the semipermeable membrane is continued, water from the hypotonic solution infiltrates the sample solution, and the additional water together with the polar solvent in the sample solution separates from the nonpolar solvent in the sample solution. That is, the sample solution divides into a bottom layer consisting of the nonpolar solvent and a top layer consisting of the polar solvent. When the sample solution contains gangliosides, a thin (membrane-like) middle layer forms between the top and bottom layers. In this way, if contact between the sample solution and hypotonic solution via the semipermeable membrane is continued, the sample solution forms two (top and bottom) or three (top, middle and bottom) layers. Components other then glycolipids (such as phospholipids, salts and the like) are distributed in the top layer, gangliosides are distributed in the middle layer and glycolipids other than gangliosides are distributed in the bottom layer. Consequently, a fraction containing glycolipids can be separated from a sample solution by separating the middle and/or bottom layer. Moreover, a fraction containing gangliosides can be separated from a sample solution by separating the middle layer.

Because the middle and bottom layers contain most of the glycolipids from the sample solution, glycolipids can be separated with high recovery by separating the middle and bottom layers. Moreover, because the middle layer contains most of the gangliosides in the sample solution, gangliosides can be separated with high recovery by separating the middle layer.

Moreover, because in addition to gangliosides with sialic acid residues the middle layer also contains asialogangliosides, which are gangliosides with the sialic acid residues removed, multiple types of glycolipids can be recovered by separating the middle and bottom layers without changing the separation conditions.

In addition, although the gangliosides contained in the middle layer and the glycolipids contained in the middle and/or bottom layer are of high purity, they can if necessary be purified still further by thin layer chromatography (TLC), high performance thin layer chromatography (HPTLC) or high performance liquid chromatography (HPLC).

The present invention is explained in more detail below using examples.

### EXAMPLE 1

Glycolipids were separated from a biological sample by Method 1, Method 2 and Method 3 below. Method 1 is the method for separating glycolipids of the present invention, while Method 3 is a conventional method.

[Method 1]

Hemispheres (200 to 260 mg) of the brains of Sandhoff disease model mice (Jackson Laboratories) were first homogenized with 1 ml distilled water, and re-homogenized following addition of 12 ml chloroform:methanol (capacity ratio 2:1). Next 60 μl pyridine was added, and incubation was performed for 2 days at 50° C. to obtain an extract containing total lipids (simple lipids, phospholipids and glycolipids).

This extract was filtered to remove proteins and residue, and hydrolyzed by addition of 4 ml of 50 mM sodium hydroxide/methanol solution, hydrolyzing the ester bonds of the phospholipids, after which neutralization was performed by addition of 40 μl of 1 N sodium acetate/methanol solution to obtain a sample solution.

The sample solution was placed in a cellophane tube and left to soak in distilled water. The equilibration effect caused distilled water to enter the cellophane tube, and after about 2 hours the sample solution had divided into three layers, a top layer, a middle layer and a bottom layer. The top layer, middle layer and bottom layer were separated and each dried.

[Method 2]

The glycolipids contained in the sample solution prepared in Method 1 were separated by thin layer chromatography.

[Method 3]

Hemispheres (200 to 260 mg) of the brains of Sandhoff disease model mice were extracted with chloroform:methanol (capacity ratio 2:1) and chloroform:methanol:distilled water (capacity ratio 1:2:0.8), to obtain an extract containing total lipids (simple lipids, phospholipids and glycolipids).

This extract was passed through a DEAE-Sephadex column, and the acidic glycolipids were then eluted with chloroform:methanol:0.8 N sodium acetate (1:2:0.8). After being hydrolyzed with 0.1 N sodium hydroxide/methanol solution, they were neutralized with 1 N acetic acid and desalted in a reverse phase column (Seppack C18) The glycolipids obtained by Method 1, Method 2 and Method 3 above were dissolved in chloroform:methanol (capacity ratio 2:1), developed with chloroform:methanol:0.25% CaCl₂ (60:35:8) on silica gel plates, and color developed on hot plates by spraying of anthrone-sulfuric acid. The bands on the plates were quantified with a chromatoscanner (Shimadzu CS-930), and the recovery rates of glycolipids obtained by the various methods were analyzed comparatively along with the compositions of the recovered glycolipids. Sialic acid was assayed by the thiobarbituric acid method (Aminiitt, D. (1961), Biochem J, 81:384-392), and glycolipids by the phenol/sulfuric acid method (Dubois, M (1956), Anal. Chem. 28:350).

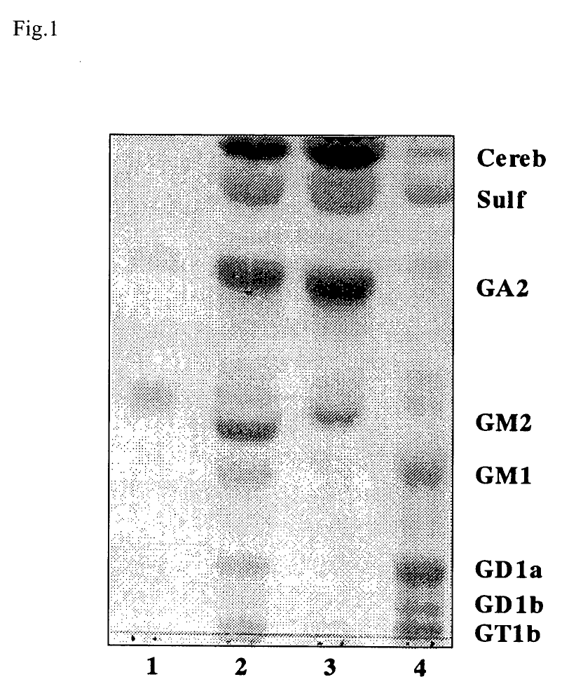

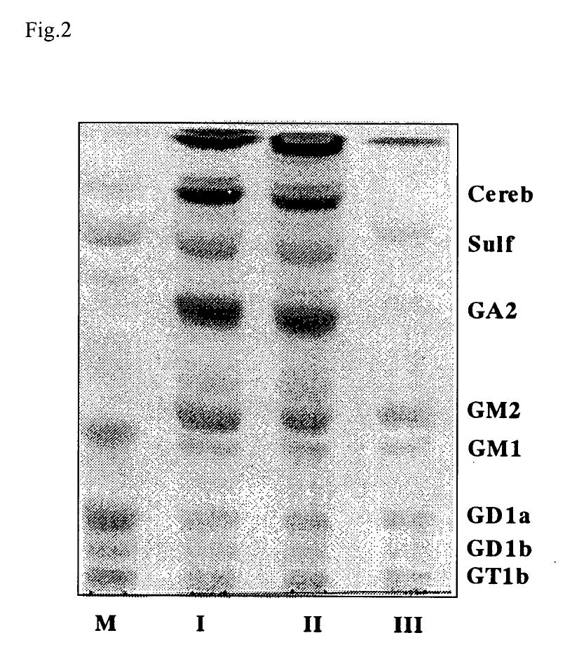

The development results of thin layer chromatography are shown in FIGS. 1 and 2. FIG. 1 shows the development results for glycolipids obtained by Method 1, with lane 1 being the glycolipids contained in the top layer, lane 2 the glycolipids contained in the middle layer, lane 3 the glycolipids contained in the bottom layer and lane 4 a molecular weight marker. FIG. 2 shows the development results for glycolipids obtained by methods 1-3, with lane M being a molecular weight marker, lane I glycolipids contained in the middle layer obtained by Method 1, lane II the glycolipids obtained by Method 2 and lane III the glycolipids obtained by method 3.

As shown in FIG. 1, no lipids were found in the upper layer (lane 1) apart from trace amounts of glycolipids. Cholesterol, cerebrosides (Cereb), sulfatides (Sulf) and gangliosides (GA2, GM2, GM1, GD1a, GD1b, GT1b) were found in the middle layer (lane 2). Cholesterol, cerebrosides (Cereb), sulfatides (Sulf) and gangliosides (GA2, GM2) were found in the bottom layer (lane 3).

Consequently, it was shown that total lipids are contained in the middle and bottom layers, and that total lipids can be obtained by separating the middle and bottom layers. Moreover, it was shown that most gangliosides are contained in the middle layer, and that gangliosides can be obtained by separating the middle layer.

Moreover, it was shown that the gangliosides contained in the middle layer include not only gangliosides with sialic acid residues (GM2, GM1, GD1a, GD1b, GT1b), but also asialogangliosides (GA2 (asialo GM1)) which are gangliosides with the sialic acid residues removed and glycolipids such as globosides, so that by separating the middle and bottom layers it is possible to recover multiple kinds of glycolipids without changing the separation conditions.

As shown in FIG. 2, the development results for glycolipids contained in the middle layer obtained by Method 1 roughly match the development results for glycolipids obtained by Method 2, showing that using Method 1 the same types of glycolipids can be separated and purified as by chromatography. Moreover, the volume of glycolipids recovered by Method 1 was 4.7% greater in terms of sugars and 9.8% greater in terms of sialic acid than that obtained by Method 2, proving that Method 1 can separate and refine glycolipids with about the same recovery as chromatography.

Moreover, as shown in FIG. 2, the glycolipids contained in the middle layer obtained by Method 1 are more diverse than the glycolipids obtained by Method 3, and the recovery is higher, proving that Method 1 can separate and purify multiple types of glycolipids with a higher recovery than the conventional method. The reason that the volume of glycolipids recovered by Method 3 was less than half that obtained by Method 1 and Method 2 was that the neutral glycolipid GA2 was excluded by the DEAE-Sephadex column.

### EXAMPLE 2

Glycolipids were also separated by Method 1 from biological samples other than the brains of Sandhoff disease model mice.

The biological samples used were brain, kidney, spleen, liver, heart, lung, uterus, testes and pancreas samples.

Glycolipids obtained by Method 1 were first dissolved in chloroform:methanol (capacity ratio 2:1), developed on silica gel plates with chloroform:methanol:0.25% CaCl₂ (60:35:8), and color developed on hot plates by spraying of anthrone-sulfuric acid. The bands on the plates were quantified with a chromatoscanner (Shimadzu CS-930), and the recovery rates of glycolipids were analyzed comparatively along with the compositions of the recovered glycolipids.

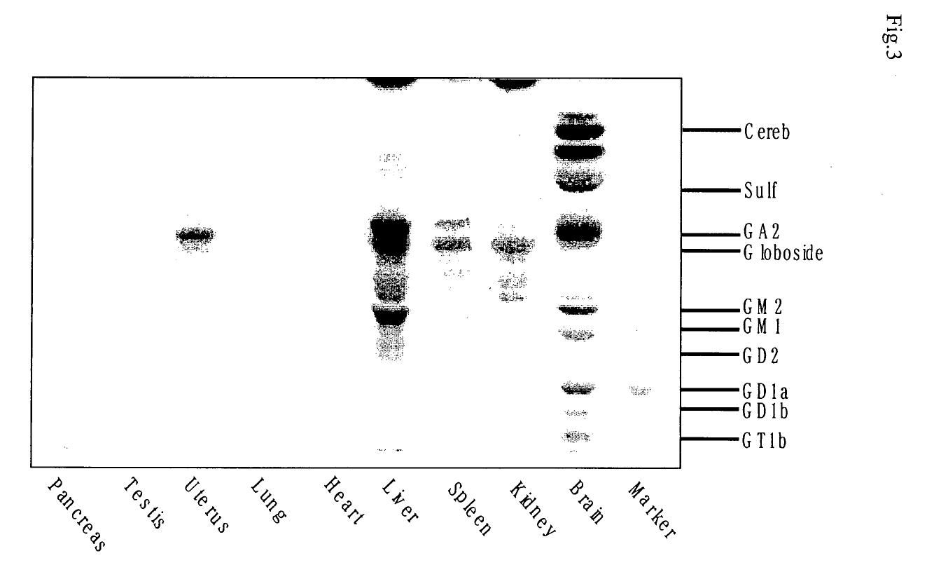

The results are shown in FIG. 3.

As shown in FIG. 3, GM2, GA2 and GD2 which had accumulated in the liver, spleen, uterus and brain could be purified from those organs, and globosides from the kidneys. It was also possible to purify minute amounts of gangliosides which had not accumulated but existed naturally. It is worth noting that in addition to the ganglio series, globo and lacto series were also purified at the same time. The basic sugar chain series of glycolipids include the ganglio series, globo series, lacto series, isoglobo series, neolacto series, isoganglio series, lactoganglio series and the like, and these results suggested the possibility of purifying all basic sugar chain series including the ganglio series all at once under the same conditions.

### INDUSTRIAL APPLICABILITY

A method for separating glycolipids is provided by the present invention. The method for separating glycolipids of the present invention can process a large number of samples easily and at low cost, and can recover multiple types of glycolipids with high recovery. These results are particularly striking when gangliosides are the target of separation.

1. A method for separating glycolipids, comprising:
(a) a step in which a sample solution obtained by hydrolysis of an extract derived from a biological sample with a mixture of a nonpolar solvent and a polar solvent is brought into contact via a semipermeable membrane with a solution having lower osmotic pressure than the sample solution; and
(b) a step in which the contact is continued until the sample solution divides into two or three layers, and the middle layer and/or bottom layer are/is separated.

2. The method according to claim 1, wherein the glycolipids are gangliosides, and the contact in step (b) is continued until the sample solution divides into three layers and the middle layer is separated.

3. The method according to claim 1 or 2, wherein the biological sample comprises a cell or tissue of an animal or plant, or a microbial body.

4. The method according to any of claims 1 through 3, wherein the nonpolar solvent is chloroform, pyridine or a mixture of these, and the polar solvent is water, methanol, sodium acetate or a mixture of two or more of these.

5. The method according to any of claims 1 through 3, wherein the mixture of the nonpolar solvent and the polar solvent is a mixture of water, methanol, chloroform and pyridine.

6. The method according to any of claims 1 through 5, wherein the sample solution is obtained by hydrolyzing and then neutralizing the extract.
